(19) United States
(12) Patent Application Publication
(10) Pub. No.: US 2024/0011461 A1
(43) Pub. Date: Jan. 11, 2024

(54) WIND TURBINE ROTOR BLADE

(71) Applicant: Siemens Gamesa Renewable Energy A/S, Brande (DK)

(72) Inventor: Guillem Junca, Vejle (DK)

(21) Appl. No.: 18/037,389

(22) PCT Filed: Nov. 10, 2021
(86) PCT No.: PCT/EP2021/081277

§ 371 Date: May 17, 2023

(30) Foreign Application Priority Data
Nov. 25, 2020 (EP) 20209748.1

(51) Int. Cl. F03D 1/06; F03D 7/02; F03D 7/04

(52) U.S. Cl. CPC F03D 1/0648; F03D 1/0685; F03D 7/022; F03D 7/042; F05B 2220/30; F05B 2240/221; F05B 2240/31

(57) ABSTRACT

A wind turbine rotor blade is provided including a deformation arrangement, which deformation arrangement includes a plurality of linear actuators, wherein each linear actuator is arranged at the suction side of the rotor blade, wherein a longitudinal axis of a linear actuator is aligned with a longitudinal axis of the rotor blade, and wherein each linear actuator is realized to alter its length in response to an excitation signal; and an interface configured to receive a corrective control signal and to issue excitation signals to the linear actuators on the basis of the corrective control signal. Also provided is a wind turbine and a method of operating a wind turbine.

### CROSS-REFERENCE TO RELATED APPLICATIONS

This application claims priority to PCT Application No. PCT/EP2021/081277, having a filing date of Nov. 10, 2021, which claims priority to European Application No. 20209748.1, having a filing date of Nov. 25, 2020, the entire contents both of which are hereby incorporated by reference.

### FIELD OF TECHNOLOGY

The following describes a wind turbine rotor blade, a wind turbine, and a method of operating a wind turbine.

### BACKGROUND

Horizontal-axis wind turbines with long rotor blades must implement some measure of preventing collisions between the rotor blades and the tower. It is usual for rotor blades to undergo some amount of flap-wise bending as a result of wind loading. However, high wind loading from wind gusts or turbulence may result in severe deflection of a rotor blade in the downwind direction, i.e., in the direction of the tower.

The downwind deflection of a rotor blade may be understood as the change in blade tip position relative to its unloaded state, in the direction of the tower. For a rotor blade with a length in the order of 100 m, a downwind deflection in the range of 12 m may be regarded as acceptable, whereas any downwind deflection beyond 15 m may be regarded as severe.

A severely deflected rotor blade may collide with the tower as it passes through the “six o'clock” position. This can be avoided for example by manufacturing “pre-bent” rotor blades that curve into the upwind direction when there is no significant wind loading, and which “straighten out” under high wind loading. Another counter-measure is to construct the wind turbine so that its axis of rotation is tilted upwards from the horizontal, so that the rotor blades are given more clearance in the “six o'clock” position.

It is known to mitigate downward deflections of the rotor blades by adjusting the rotor blade pitch angles. However, the pitch angle is generally set so that the aerodynamic rotor can extract as much energy as possible from the wind. If the pitch angle is altered to turn the rotor blade out of the wind, the result is a decrease in rotational velocity of the aerodynamic rotor and a corresponding reduction in power output. This conventional approach is therefore regarded as an undesirable but necessary trade-off between damage prevention and power output.

Furthermore, each downwind deflection of the rotor blade results in compressive forces in the rotor blade shell on the suction side. A wind turbine rotor blade has a certain degree of flexibility, and is constructed to recover from intermittent elastic deformations. However, a rotor blade may undergo many thousands of severe deflections every year, and the resulting accruing of fatigue damage may significantly shorten the lifetime of the rotor blade. As a result, fatigue damage from downwind deflections of the rotor blades can contribute significantly to the overall cost of energy.

### SUMMARY

An aspect related to an improved way of mitigating the downwind deflection of a rotor blade.

According to embodiments of the invention, the wind turbine rotor blade comprises a deformation arrangement, which deformation arrangement comprises at least one series arrangement of linear actuators, each comprising a plurality of linear actuators, wherein each linear actuator is arranged at the suction side of the rotor blade, wherein a longitudinal axis—the “working axis”—of a linear actuator is essentially aligned along a longitudinal axis of the rotor blade, and wherein each linear actuator is realized to alter its length along its working axis in response to an excitation signal. The deformation arrangement further comprises an interface configured to receive a corrective control signal and to issue excitation signals to the linear actuators. The collective effect of adjusting the lengths of the linear actuators is to effect a deformation of the rotor blade to counteract a compression of the suction side. In this way, the inventive deformation arrangement can effect a counter-deformation of the rotor blade, correcting its shape towards the upwind direction.

A linear actuator in the context of embodiments of the invention can be any suitable type of linear actuator, i.e., any actuator that can effect movement along a linear axis. The working length of the linear actuator can be adjusted relative to a default (“resting”) length. Depending on its realization, a linear actuator can alter its length in discrete steps or smoothly over a continuum.

In one approach, a linear actuator may be compressed when the rotor blade is deflected in the downwind direction, and this type of linear actuator may counteract the compression by extending to increase its length. In an alternative approach, a linear actuator may be stretched or extended when the rotor blade is deflected in the downwind direction, and this type of linear actuator may counteract the extension by contracting to reduce its length. In the following, without restricting embodiments of the invention in any way, it shall be assumed for the sake of discussion that linear actuators of the first kind are used, i.e., linear actuators that counteract a compression by extending their lengths. It shall be understood that each linear actuator can be controlled to alter its length between a default length and a maximum extension length. The achievable extension will depend on the actual realization of the linear actuator. The linear actuators may be identical (having the same extension range) or different (having different extension ranges).

A decision to adjust the lengths of the linear actuators can be made locally by the wind turbine controller, or can be made at a remote location, for example by a wind park controller.

An advantage of the inventive rotor blade is that it can easily modify its shape to counteract a downwind deflection. As explained above, a flap-wise bending moment causes the rotor blade to deflect downwind, towards the tower. The action of extending the linear actuators introduces an axial force in the rotor blade. This axial force is offset from the elastic axis of the rotor blade and therefore causes a bending moment in the opposite direction to the flap-wise moment, i.e., in the upwind direction, thereby bending the rotor blade away from the tower.

The inventive rotor blade allows the extent of deflection to be controlled directly, without any need of modifying the pitch angle. Excessive downwind deflection can therefore be avoided without any reducing power production.

The components of the deformation arrangement are chosen according to the physical properties of the rotor blade, for example its elasticity, its mass, its length, etc.

According to embodiments of the invention, the wind turbine comprises a number of such rotor blades, usually three, mounted to a hub or spinner. The wind turbine comprises a monitoring arrangement that is realized to determine the extent of downwind deflection of a rotor blade from wind loading; and an analysis unit configured to determine a corrective deformation of that rotor blade to counteract the downwind deflection and to generate a corresponding corrective control signal to the deformation arrangement of that rotor blade.

The inventive wind turbine can continue to deliver optimum output power even during unfavorable wind conditions such as a high-speed gusts or turbulence, since it is not necessary to pitch the rotor blades out of the wind. Furthermore, the rotor blades of the inventive wind turbine can be protected from fatigue damage arising from vortex-induced vibrations during a stand-still mode. The monitoring arrangement can determine the frequency and amplitude of the vortex-induced vibrations, and the analysis unit can determine a corrective deformation to be effected in each “downwind” half-cycle of the vortex-induced vibrations.

The inventive method of operating such a wind turbine comprises the steps of determining an actual or predicted downwind deflection of a rotor blade from wind loading; determining the magnitude of a length correction to be effected by the deformation arrangement of that rotor blade to counteract the downwind deflection; generating a corrective control signal on the basis of the corrective force magnitude; and issuing the corrective control signal to the deformation arrangement of that rotor blade.

The inventive method provides a straightforward solution to actively deform the rotor blade in order to compensate for an unwanted deflection due to external loading. The inventive method can be deployed in different situations, for example by actively deflecting the rotor blade in the upwind direction during normal operation in order to prevent a collision between the rotor blade tip and the tower; or in a stand-still mode to counteract vortex-induced vibrations of the rotor blades by actively deflecting a rotor blade in the upwind direction to counteract a downwind deflection.

Embodiments and features of the invention are given by the dependent claims, as revealed in the following description. Features of different claim categories may be combined as appropriate to give further embodiments not described herein.

The outboard region of a rotor blade may be understood herein to loosely refer to the outer half of the rotor blade, while the inboard region may be understood to include the rest. The expression “root region” may be understood to comprise the cylindrical root end, and the “transition region” refers to the region between the cylindrical root end and the airfoil. The term “outboard end” of an object is the end that is closer to the rotor blade tip, and its “inboard end” is the end that is closer to the rotor blade root.

In the context of a linear actuator, the terms “first end”, “inboard end” and “inner end” are regarded as synonyms and may be used interchangeably herein. Similarly, the terms “second end”, “outboard end” and “outer end” are regarded as synonyms and may be used interchangeably herein.

In the following, it may be assumed that the wind turbine is the conventional type described above, with three rotor blades mounted to a hub. The rotor blades may have been manufactured with a “pre-bent” design, i.e., having an inherent curvature in the upwind direction.

The inventive wind turbine may determine the downwind deflection of a rotor blade in various ways. For example, a rotor blade may be equipped with strain sensors in or on its outer shell or body. Such strain sensors can detect whether the shell is undergoing compression or extension, as will be known to the skilled person. Alternatively, or in addition, the flap-wise flexion of the rotor blade under wind loading may be known, i.e., the relationship between wind speed and deflection is well-defined, so that a value of wind speed may be sufficient to determine the degree of downwind deflection. The angular position (or “azimuth angle”) of the rotor blade may also be taken into consideration, since wind shear results in greater deflection of a rotor blade at the “12 o'clock” position (azimuth angle is 0°) compared to a rotor blade at the “6 o'clock” position” (azimuth angle is 180°).

As mentioned above, a linear actuator can be any suitable type of linear actuator. For example, a linear actuator can be any of a piezoelectric motor transducer, a hydraulic cylinder, a pneumatic cylinder, an electro-mechanical actuator, etc. Combinations of these different types of linear actuators are also possible. However, to simplify control of the actuators, in an embodiment of the invention all liner actuators are of the same type, for example all linear actuators are piezoelectric motor transducers.

In an embodiment, a linear actuator is realized to extend its length by about 0.1% of its resting or default length. For example, a linear actuator can be a piezoelectric motor transducer with a length of 100 mm and a free deflection of up to 100 μm. Such piezoelectric linear actuators may be realized to achieve a push force capacity in the order of 100 kN. The strain in the shell of a rotor blade undergoing downwind deflection can be in the order of 10⁻³ m/m, and the choice of piezoelectric linear actuator will depend on its push force (or pull force) capacity, which should not exceed the strain in the rotor blade shell.

In an embodiment, all components of the deformation arrangement of a rotor blade are arranged in the interior of that rotor blade. The arrangement of linear actuators is anchored in some suitable manner to the body of rotor blade in order to be able to counteract a compression in the downwind direction. In a an embodiment of the invention, a linear actuator is at least partially embedded in the body or shell of the rotor blade. For example, a linear actuator may have anchors in the form of a rigid outboard end plate and a rigid inboard end plate. These end plates may be embedded at least partially in the body of the suction side half of the rotor blade. In an embodiment using piezoelectric motor transducers, the active portion of the transducer is located between the end plates.

In an embodiment, the linear actuators are deployed in a region further outboard than the first 20% of the rotor blade length, since the inner 20% of the rotor blade has a high inherent stiffness and generally does not undergo any significant compression through wind loading. The highest strain (from rotor blade deflection) is typically produced over 20%-50% of the rotor blade length. However, the effectiveness of a linear actuator is in direct proportion to its vicinity to the inboard blade region, i.e., the effectiveness of a linear actuator placed close to the root end is greater than an equivalent linear actuator placed further outboard.

Various possible arrangements of linear actuators are conceivable. In an embodiment of the invention, a deformation arrangement comprises a series of linear actuators. For example, a plurality of linear actuators can be installed in the rotor blade over 40%-80% of the rotor blade length. In one exemplary realization, 50 linear actuators can be installed over a length of 50 m, each linear actuator having an extension range of 1 mm. In such an embodiment, a linear actuator can be realized as a stack of smaller piezoelectric “cells”. With an appropriate choice of linear actuator, such an arrangement can counteract a severe downwind deflection of that rotor blade type.

With the components arranged as described above, the deformation arrangement can alter the deflection of the rotor blade, counteracting a downwind deflection and effecting an extension towards the upwind direction. Extending the lengths of the linear actuators will cause the rotor blade to bend flap-wise in the upwind direction. Decreasing the lengths of the linear actuators (towards their default state) will decrease the upwind deflection. In an embodiment, the net effect of the deflection arrangement is to reduce the downwind compression of the rotor blade to an acceptable level.

When multiple linear actuators of the same type are used, the effort to counteract the downwind compression can be evenly distributed, so that each linear actuator makes the same contribution. Alternatively, linear actuators with different capabilities may be installed in different regions of the rotor blade. For example, one or more primary arrangements of more powerful linear actuators may be installed in a rotor blade region that generally undergoes significant compression, and one or more secondary arrangements of less powerful linear actuators may be installed in regions that generally undergo less compression.

The analysis unit of a control arrangement can determine a corrective suction-side “length extension” to be effected for three rotor blades in order to counteract the suction-side compression, whereby the term “length extension” shall be understood to mean the collective length by which the linear actuators of a deformation arrangement must be extended in order to counteract the suction-side downwind compression. However, as explained above, wind shear and rotor blade angular position can determine the amount of downwind deflection during normal operation of the wind turbine, as well as during a stand-still mode. Therefore, in an embodiment of the invention, the analysis unit of the control arrangement is configured to determine a corrective “length extension” for each deformation arrangement independently. A 100 m rotor blade near the “six o'clock position” may require a corrective length extension of 5 cm, for example, while the same rotor blade near the “twelve o'clock position” may not require any corrective action. Of course, the corrective length extension depends on many factors such as rotor blade length, wind speed, wind shear, etc.

During mild wind conditions in normal operation of the wind turbine, downwind deflection of the rotor blades is generally not severe, and no correction need be necessary. Therefore, in an embodiment of the invention, the step of computing a corrective suction side length extension is carried out in unfavorable wind conditions, for example when the wind speed exceeds a minimum threshold, during turbulence, or during high-speed gusts. During a stand-still mode (the wind turbine is not generating output power, and the aerodynamic rotor does not turn or turns only very slowly), the step of computing a corrective suction side length extension may only be necessary if vortex-induced vibrations are causing downwind deflection of the rotor blades.

### BRIEF DESCRIPTION

Some of the embodiments will be described in detail, with reference to the following figures, wherein like designations denote like members, wherein:

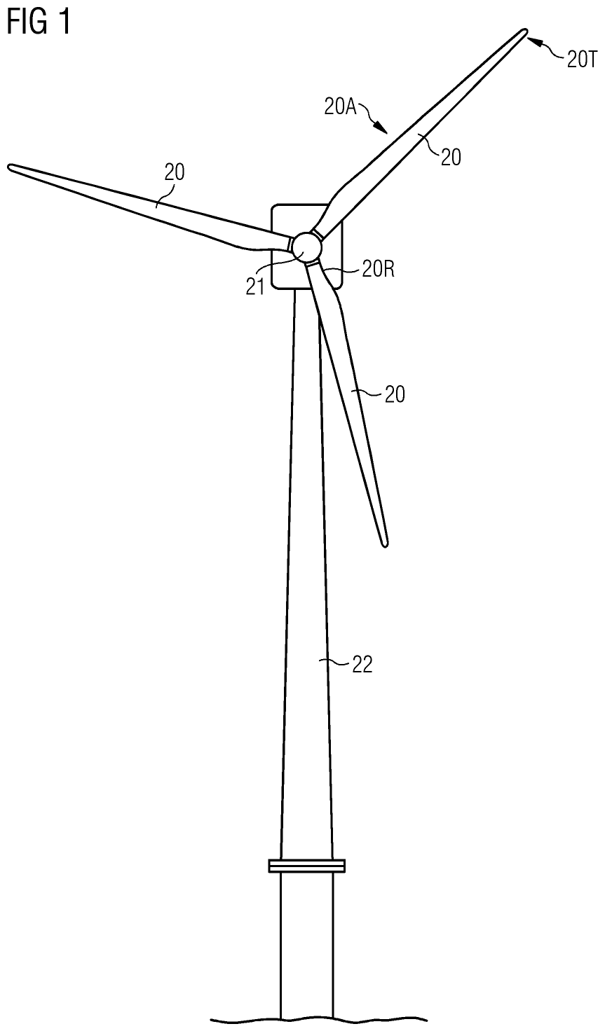

FIG. 1 shows a wind turbine;

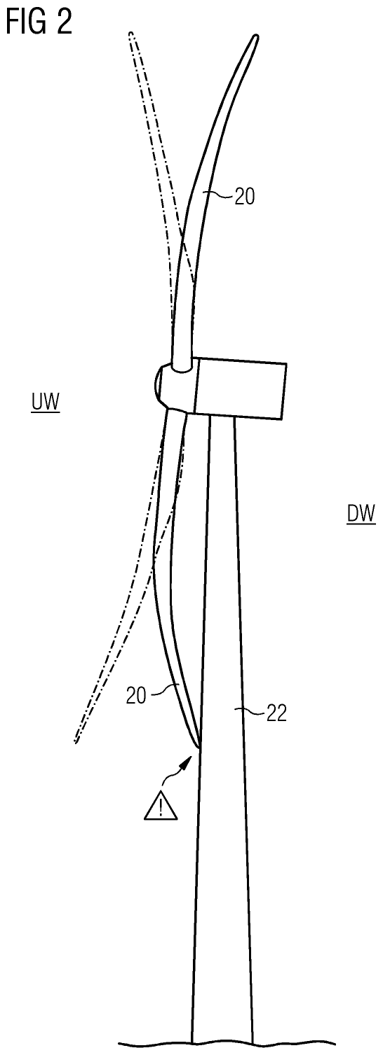

FIG. 2 illustrates deflection of a rotor blade;

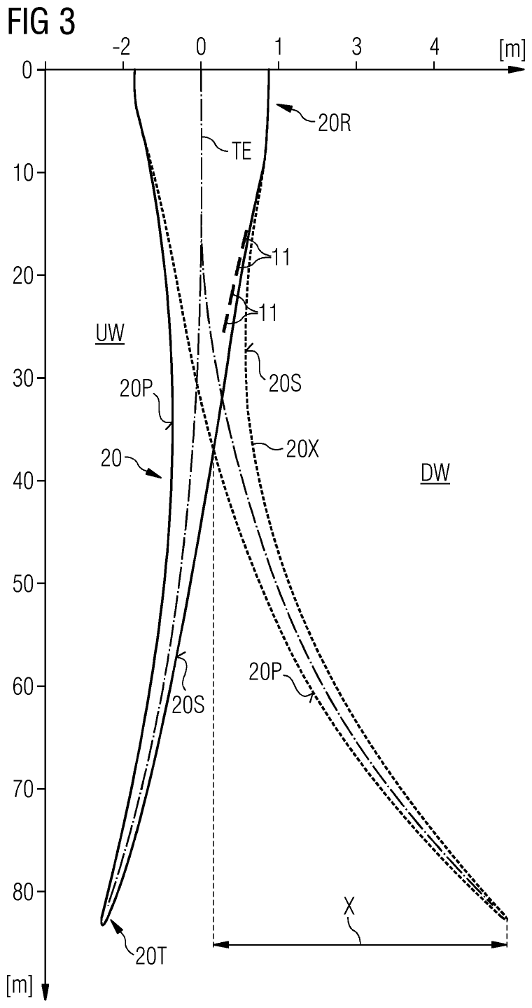

FIG. 3 shows a schematic of a rotor blade according to embodiments of the invention;

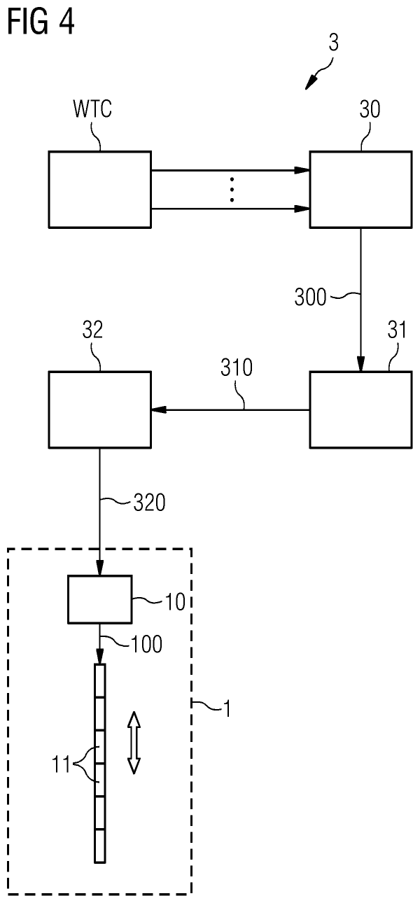

FIG. 4 shows a block diagram of a control arrangement in an embodiment of the wind turbine;

FIG. 5 shows curves associated with the rotor blade during normal operation, according to embodiments of the present invention;

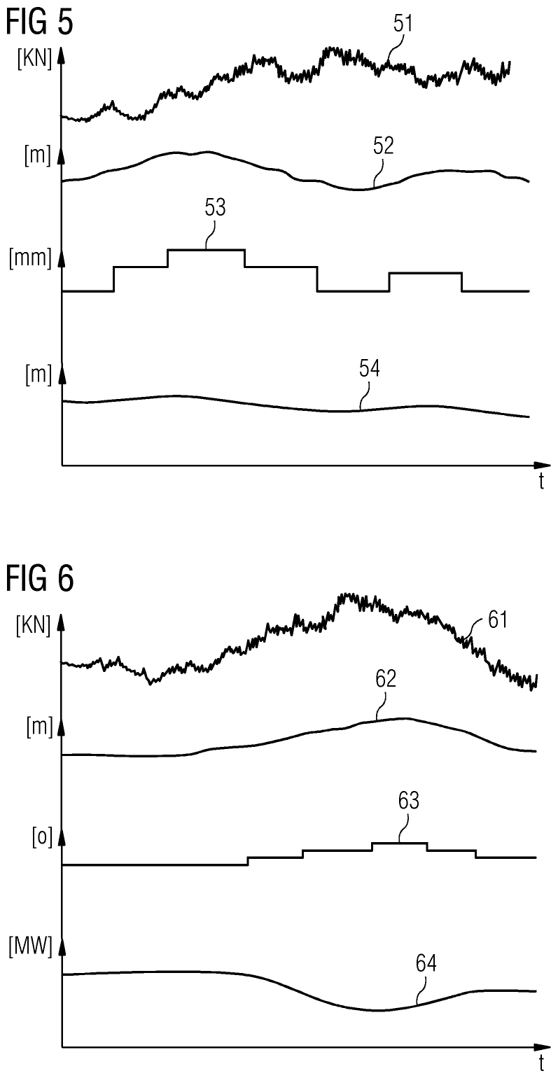

FIG. 6 shows curves associated with a conventional rotor blade during normal operation;

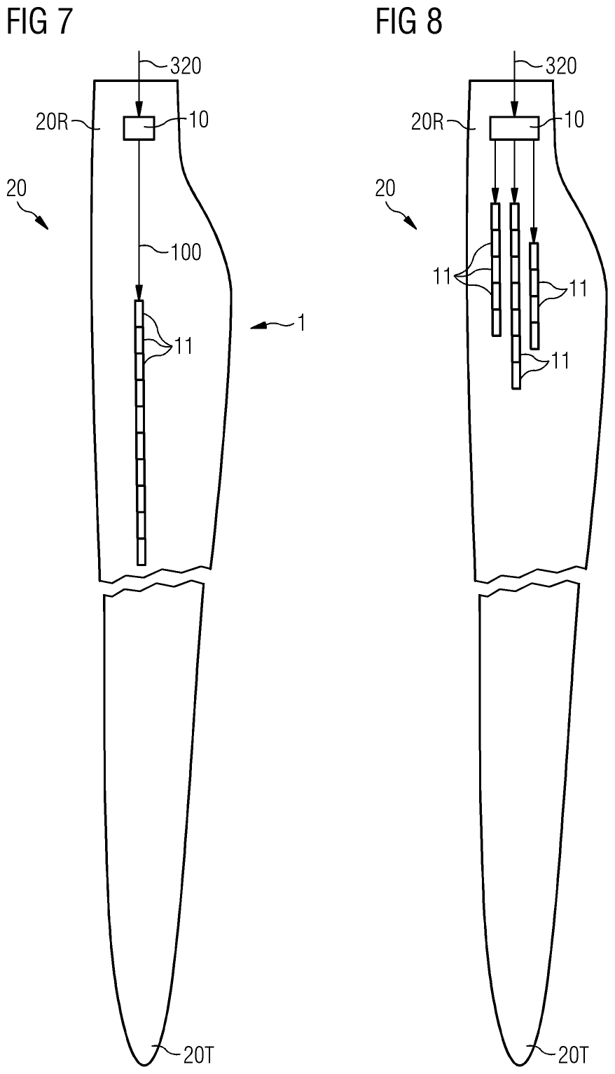

FIG. 7 shows a first embodiment of the rotor blade;

FIG. 8 shows a second embodiment of the rotor blade;

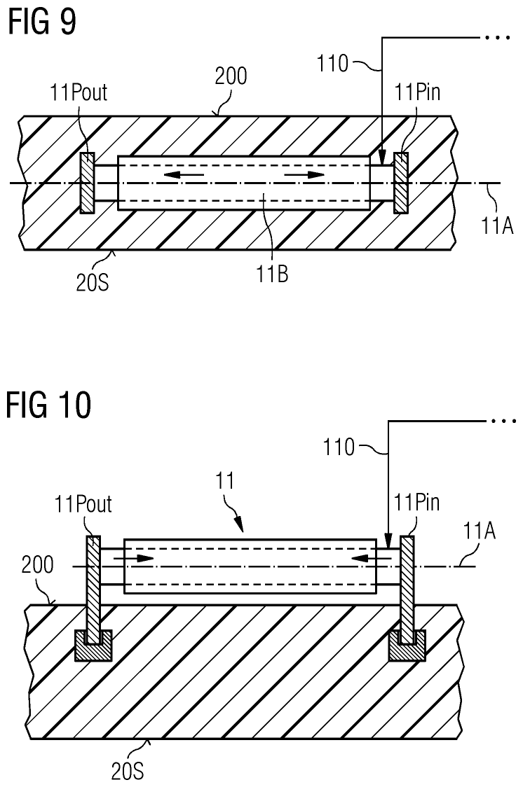

FIG. 9 shows an exemplary implementation of a linear actuator in an embodiment of the rotor blade; and

FIG. 10 shows another exemplary implementation of a linear actuator in an embodiment of the rotor blade.

### DETAILED DESCRIPTION

FIG. 1 shows a wind turbine 2 of the most common type in use at present. The wind turbine 2 has an aerodynamic rotor comprising three rotor blades 20 attached to a hub 21. Rotation of the aerodynamic rotor causes rotation of a generator rotor, so that output power can be exported by the wind turbine 2.

The rotor blades 20 are shaped to optimize the amount of energy that can be extracted from the wind. To this end, a rotor blade 20 has an airfoil portion over much of its length, and the shape of the rotor blade transitions from a generally circular shape at the root end 20R to the flatter airfoil portion 20A, ultimately tapering to a thin tip 20T. The length of a rotor blade can be in the order of 80 m or more. This type of rotor blade may undergo significant deflection in the downwind direction, as illustrated in FIG. 2, which shows how the rotor blades 20 of such a wind turbine may be deflected by high wind loading in the downwind direction DW, i.e., in the direction of the tower 22. The downwind side DW and upwind side UW of the aerodynamic rotor are indicated. In this exemplary wind turbine, the axis of rotation is tilted upwards by several degrees and the rotor blades are pre-bent as indicated by the ghost outlines that show their “resting” shape in low wind conditions.

FIG. 3 shows a schematic of a rotor blade according to embodiments of the invention. The diagram is a view of the rotor blade looking at the trailing edge TE. It shall be noted that the axes are not to the same scale. The diameter at the root end 20R is in the order of 3-4 m (X-axis), and the rotor blade length is in the order of 80-90 m (Y-axis). The pressure side 20P and suction side 20S of the rotor blade 20 are shown as indicated. It shall be assumed that the wind turbine is controlled so that its aerodynamic rotor always faces upwind UW during normal operation.

The diagram shows a deflection shape (dotted line) to indicate the shape of an equivalent conventional rotor blade 20X under high wind conditions without corrective pitch control. Deflection can be measured from a reference, for example relative to a vertical line extending through 0 of the X-axis. The significant tip-to-tower deflection X of the conventional rotor blade 20X can have undesirable effects such as fatigue loading, tower collision, etc. For this reason, a conventional rotor blade is generally pitched out of the wind to decrease the tip-to-tower deflection X, resulting in a reduction in output power during normal operation. In the inventive rotor blade 20, such extreme downwind deflection is prevented by its deformation arrangement, indicated here schematically to comprise a series of linear actuators 11 embedded at least partially at the suction-side 20S of the rotor blade 20. In this exemplary embodiment, a series of linear actuators is indicated at an inboard blade region. Each linear actuator may comprise a stack of piezo-electric cells, for example. In response to a corrective control signal, the linear actuators extend their lengths to counteract the downwind deflection, assisting the rotor blade 20 to return towards its normal shape, i.e., compression of the suction side is counteracted.

The corrective control signal 320 for the linear actuators can originate from an actuator control unit 32 as indicated in FIG. 4, which shows a block diagram of a wind turbine control arrangement 3. In this exemplary embodiment, a monitoring arrangement 30 determines the downwind deflection 300 associated with the momentary wind loading on a rotor blade 20. The monitoring arrangement 30 may base its computations on relevant input variables such as wind speed, rotor blade angular position, rotor blade pitch angle etc., which can be supplied by the wind turbine controller WTC. Analysis unit 31 determines the magnitude of the length correction 310 that must be effected by the deformation arrangement 1 (indicated here only schematically) of that rotor blade in order to counteract the suction-side compression of the rotor blade. Analysis unit 31 may be provided with any relevant information such as the rotor azimuth angle, the rotor blade pitch angle, blade loading, a measurement of tip-to-tower clearance etc., which can be supplied by the wind turbine controller WTC. In one example, the monitoring arrangement 30 may determine that the current wind loading would result in a deflection of 3 m relative to a reference. Analysis unit 31, knowing the present state of the deformation arrangement 1, determines the “length correction” that will be required to counteract the longitudinal compression of the suction-side to avoid severe deflection. The actuator control unit 32 translates the length correction 310 into an appropriate actuator control signal 320 that is then issued to the linear actuators of the deformation arrangement 1 of that rotor blade. In this way, the control arrangement 3 mitigates, prevents or counteracts the downwind deflection of that rotor blade.

The exemplary control arrangement 3 described above comprises the monitoring arrangement 30, the analysis unit 31, and the actuator control unit 32. One or more components of the control arrangement can be realized locally in a wind turbine or at a remote location.

The computations described above can be carried out for all three rotor blades collectively, i.e., a single length correction 310 is determined and converted into a corrective actuator control signal 320 that is issued to the deformation arrangements of all three rotor blades. However, since the downwind deflection is affected by wind shear and angular rotor blade position, the downwind deflection 300, corrective lengths 310 and actuator control signals 320 can be computed independently for each rotor blade.

Since wind loading on the rotor blades will fluctuate, the corrective force magnitude 310 can fluctuate accordingly. This is indicated in FIG. 5, which shows curves for wind load 51, predicted downwind deflection 52, corrective lengths 53 and actual downwind deflection 54 respectively for a rotor blade according to embodiments of the invention. The diagram shows that corrective actuation of the linear actuators counteracts the suction-side compression and prevents significant downwind deflection. This pre-emptive or “counter-deformation” of the rotor blades means that the wind turbine controller does not need to adjust the pitch angle to avoid rotor blade damage, but can continue to operate at the favorable high-power output. The pitch angle and power output can remain essentially constant. The predicted downwind deflection 52 may correspond to the output of the monitoring arrangement 30, and the corrective lengths 53 may correspond to the output 310 of the analysis unit 31 as explained in FIG. 4 above.

The conventional approach of adjusting the pitch angle to mitigate downwind deflection is illustrated in FIG. 6, which shows curves for wind load 61, downwind deflection 62, pitch angle correction 63 and power output 64 respectively. The diagram illustrates how downwind deflection can only be avoided by adjusting the rotor blade pitch angle, which in turn results in a decrease in output power.

FIG. 7 shows a schematic diagram of a possible embodiment of the inventive rotor blade 20, indicating the deformation arrangement 1 in the interior of the rotor blade. The diagram shows a series of linear actuators 11 arranged along an inboard region of the rotor blade 20. Each linear actuator 11 can comprise a stack of piezoelectric motor transducers that act together as a unit. Each linear actuator 11 is at least partially embedded in the suction-side body of the rotor blade. A length correction input 320 is converted to an appropriate excitation signal 100 by an interface module 10. For example, in an arrangement using ten piezoelectric units 11, each comprising a piezoelectric stack, a length correction input 320 corresponding to “3 cm” may be converted to a suitable input 100 voltage that causes each of the ten units 11 to extend its length by 3 mm.

FIG. 8 shows a schematic diagram of another possible embodiment of the inventive rotor blade 20. Here, three series of linear actuators 11 is implemented, and each linear actuator can comprise a stack of piezoelectric motor transducers that act together as a unit. The units 11 may all be identical. Alternatively, each series may comprise units 11 of the same type, but units 11 of one series may differ from the units 11 of the other series.

FIG. 9 shows a very simplified exemplary embodiment in which a piezoelectric motor transducer 11 is embedded in the suction-side body 20S or shell of the rotor blade. The longitudinal axis 11A of the linear actuator is essentially in line with a longitudinal axis of the rotor blade. The linear actuator 11 has a rigid outboard end plate 11Pout and a rigid inboard end plate 11Pin. These end plates 11Pin, 11Pout are embedded in the suction-side body 20S and serve as anchors. The active portion 11B of the transducer is located between the end plates 11Pin, 11Pout. Depending on the magnitude of the input voltage 100, the active portion 11B of the transducer will extend or contract, as will be known to the skilled person. In this embodiment, the linear actuator is arranged in line with its anchors.

FIG. 10 shows an alternative arrangement, in which the linear actuator is upwind of its anchors. In such an embodiment, compression of the suction side will extend or stretch the active portion of the linear actuator. Here, the linear actuator is configured with a negative free deflection, i.e., it will contract or reduce its length in response to a suitable input voltage.

Although the present invention has been disclosed in the form of embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.

1-15. (canceled)

16. A wind turbine rotor blade comprising:
a deformation arrangement, wherein the deformation arrangement comprises:
at least one series arrangement of linear actuators, each comprising a plurality of linear actuators, wherein each linear actuator is arranged at a suction side of the wind turbine rotor blade, wherein a longitudinal axis of a linear actuator is aligned with a longitudinal axis of the wind turbine rotor blade, wherein each linear actuator is at least partially embedded in a body of the wind turbine rotor blade and is configured to alter a length in response to an excitation signal; and
an interface configured to receive a corrective control signal and to issue excitation signals to the plurality of linear actuators on a basis of the corrective control signal.

17. The wind turbine rotor blade according to claim 16, wherein each linear actuator comprises a rigid outboard end plate and a rigid inboard end plate embedded at least partially in the body of the suction side of the wind turbine rotor blade.

18. The wind turbine rotor blade according to claim 16, wherein components of the deformation arrangement are arranged to counteract a compression of the wind turbine rotor blade in a downwind direction.

19. The wind turbine rotor blade according to claim 16, wherein each linear actuator is any of a piezoelectric motor transducer, a hydraulic cylinder, a pneumatic cylinder, an electro-mechanical actuator.

20. The wind turbine rotor blade according to claim 16, wherein each linear actuator is configured to alter a length by up to 0.1% of a resting length.

21. The wind turbine rotor blade according to claim 20, wherein each linear actuator comprises a stack of piezoelectric cells.

22. The wind turbine rotor blade according to claim 16, wherein the at least one series arrangement comprises at least twenty linear actuators, or at least forty linear actuators.

23. The wind turbine rotor blade according to claim 16, wherein the plurality of linear actuators are located in a vicinity of a rotor blade root region.

24. The wind turbine rotor blade according to claim 16, wherein each linear actuator comprises a number of attachment means for attaching the linear actuator to the body.

25. A wind turbine comprising:
a plurality of wind turbine rotor blades according to claim 16;
a monitoring arrangement configured to determine a downwind deflection of a rotor blade from wind loading; and
an analysis unit configured to determine a corrective deformation of the rotor blade to counteract the downwind deflection and to generate a corresponding corrective control signal to the deformation arrangement of the rotor blade.

26. The wind turbine according to claim 25, configured to determine a corrective deformation for each wind turbine rotor blade independently.

27. The wind turbine according to claim 25, wherein each rotor blade comprises an inherent curvature in an upwind direction.

28. A method of operating a wind turbine according to claim 25, the method comprising:
determining a downwind deflection of a rotor blade from wind loading;
determining a magnitude of a corrective length to be effected by the deformation arrangement of the rotor blade to counteract the downwind deflection;
generating a corrective control signal on a basis of a corrective force magnitude; and
issuing the corrective control signal to the deformation arrangement of the rotor blade.

29. The method according to claim 28, wherein the downwind deflection of the rotor blade is determined from a strain sensor arrangement and/or from a wind speed monitoring arrangement.

30. The method according to claim 28, wherein computing the corrective force is carried out when wind speed exceeds a minimum threshold.
